(19) United States
(12) Patent Application Publication
(10) Pub. No.: US 2025/0301426 A1
(43) Pub. Date: Sep. 25, 2025

(54) WIRELESS MANAGEMENT SYSTEM AND METHOD

(71) Applicant: DELTA ELECTRONICS, INC., Taoyuan City (TW)

(72) Inventors: Yu-Wei LEE, Taoyuan City (TW); Chih-Kuan YEN, Taoyuan City (TW); Chin-Ming CHEN, Taoyuan City (TW)

(21) Appl. No.: 19/086,146

(22) Filed: Mar. 21, 2025

Related U.S. Application Data
(60) Provisional application No. 63/568,738, filed on Mar. 22, 2024.

(51) Int. Cl. H04W 56/00; H04B 1/40

(52) U.S. Cl. CPC H04W 56/0005; H04B 1/40

(57) ABSTRACT

A wireless management system and method are provided. The system synchronizes a first clock of a control substrate and a second clock of each of multiple energy storage units based on a first time calibration signal transmitted by the control substrate. The energy storage units measure energy storage devices of the energy storage units at a designated time point based on a measurement signal transmitted by the control substrate to obtain multiple measurement data, wherein the measurement signal is configured to indicate the designated time point. The control substrate obtains the measurement data corresponding to the designated time point from the energy storage units based on a reply signal transmitted by the energy storage units.

### CROSS-REFERENCE TO RELATED APPLICATION

This application claims priority to U.S. Provisional Application Ser. No. 63/568,738, filed Mar. 22, 2024, which is herein incorporated by reference in its entirety.

### BACKGROUND

### Field of Invention

The present disclosure relates to a wireless management system and method. More particularly, the present disclosure relates to a wireless management system and method for managing energy storage devices.

### Description of Related Art

In order to measure the voltage, current, temperature and other data of the energy storage devices, the current battery management system (BMS) needs to pull many wires between the management device and the energy storage devices, so that the management device can directly measure the status of each of the energy storage devices.

However, since each of the energy storage devices needs to be equipped with a wire connecting to the management device. When the number of energy storage devices increases, the number of wires connected to the management device also increases. The complicated connection wires not only increase the production cost, also increase the risk of producing and employing energy storage devices (e.g., the wires short circuiting). In addition, complicated connection wires will increase the cost of the product, making it difficult to maintain the quality and reliability of the product. Therefore, the method for managing energy storage devices using wireless communication technology provides a new solution.

In the prior art, when wireless communication technology is used to manage energy storage devices, each of the energy storage devices is directly connected to the management device for data transmission generally. However, due to the lack of mechanisms to manage signal transmission and reception, problems such as signal interference and devices unrecognition may occur, not to mention controlling the energy storage devices to execute specific operations at a designated time point.

In view of this, how to provide a wireless management technology for managing energy storage devices is the goal that the industry strives to work on.

### SUMMARY

The disclosure provides a wireless management system comprising a control substrate and a plurality of energy storage units. The control substrate comprises a first clock. A first energy storage unit of the energy storage units is communicatively connected to the control substrate, and each of the energy storage units is communicatively connected to one of the energy storage units. Each of the energy storage units comprises an energy storage device and a node substrate. The node substrate is electrically connected to the energy storage device and comprises a second clock. The wireless management system is configured to execute the following operations: synchronizing the first clock and the second clock of each of the energy storage units based on a first time calibration signal transmitted by the control substrate; the energy storage units measuring the energy storage device of each of the energy storage units at a designated time point based on a measurement signal transmitted by the control substrate to obtain a plurality of measurement data corresponding to the designated time point, wherein the measurement signal is configured to indicate the designated time point; and the control substrate obtaining the measurement data corresponding to the designated time point from the energy storage units based on a reply signal transmitted by the energy storage units.

The disclosure further provides a wireless management method, being adapted for use in a wireless management system, wherein the wireless management system comprises a control substrate and a plurality of energy storage units, and the wireless management method comprises the following steps: synchronizing a first clock of the control substrate and a second clock of each of the energy storage units based on a first time calibration signal transmitted by the control substrate; the energy storage units measuring an energy storage device of each of the energy storage units at a designated time point based on a measurement signal transmitted by the control substrate to obtain a plurality of measurement data corresponding to the designated time point, wherein the measurement signal is configured to indicate the designated time point; and the control substrate obtaining the measurement data corresponding to the designated time point from the energy storage units based on a reply signal transmitted by the energy storage units.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a wireless management system according to a first embodiment of the present disclosure.

FIG. 2 is a schematic diagram illustrating a control substrate according to some embodiments of the present disclosure.

FIG. 3 is a schematic diagram illustrating a node substrate according to some embodiments of the present disclosure.

FIG. 4 is an implementation diagram illustrating the wireless management system according to some embodiments of the present disclosure.

FIG. 5 is a schematic diagram illustrating operations of the wireless management system synchronizing the clocks according to some embodiments of the present disclosure.

FIG. 6 is a schematic diagram illustrating operations of the wireless management system measuring energy storage devices according to some embodiments of the present disclosure.

FIG. 7A is a schematic diagram illustrating a measurement signal according to some embodiments of the present disclosure.

FIG. 7B is a schematic diagram illustrating a reply signal according to some embodiments of the present disclosure.

FIG. 8 is a flow diagram illustrating a wireless management method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The wireless management system provided by the present disclosure comprises a control substrate and a plurality of energy storage units, wherein a first energy storage unit of the energy storage units is communicatively connected to the control substrate, and each of the energy storage units is communicatively connected to one of the energy storage units.

In some embodiments, the energy storage units further comprise a second energy storage unit to a n-th energy storage unit, the first energy storage unit to the n-th energy storage unit are communicatively connected in sequence pairwisely, the n-th energy storage unit is adjacent to a n−1-th energy storage unit, and n is a positive integer greater than 1.

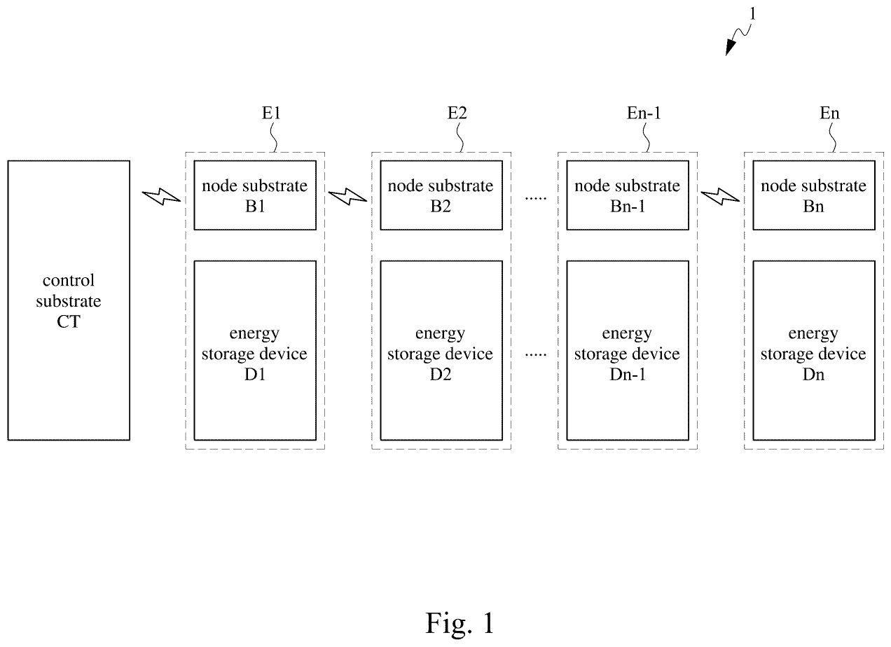

Please refer to FIG. 1, which is a schematic diagram illustrating a wireless management system according to a first embodiment of the present disclosure. The wireless management system 1 comprises a control substrate CT and n energy storage units E1-En. Each of the energy storage units E1-En comprises a node substrate and an energy storage device (i.e., node substrates B1-Bn and energy storage devices D1-Dn). The node substrates B1-Bn are electrically connected to the energy storage devices D1-Dn respectively, the energy storage unit E1 is communicatively connected to the control substrate CT via the node substrate B1, and the energy storage units E1-En are communicatively connected to one another in sequence pairwisely via the node substrates B1-Bn. In accordance, the control substrate CT and the energy storage units E1-En form a communication connection in the form of a daisy chain. In some embodiments, the energy storage devices D1-Dn comprise lithium batteries, lead-acid batteries, and/or other device for storing energy.

It is noted that, FIG. 1 illustrates one of the implementations of the wireless management system 1. However, the present disclosure is not limited thereto, and the wireless management system 1 may be implemented in other forms.

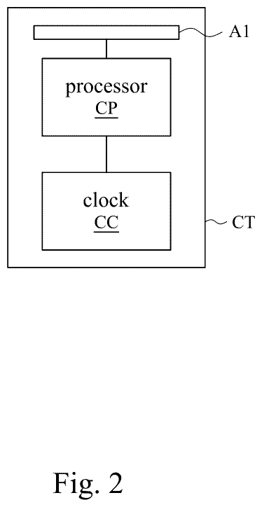

In some embodiments, the control substrate CT further comprises a first antenna. About the details of the control substrate CT, please refer to FIG. 2. The control substrate CT comprises a processor CP, a clock CC, and an antenna A1, wherein the processor CP is electrically connected to the clock CC and the antenna A1 respectively.

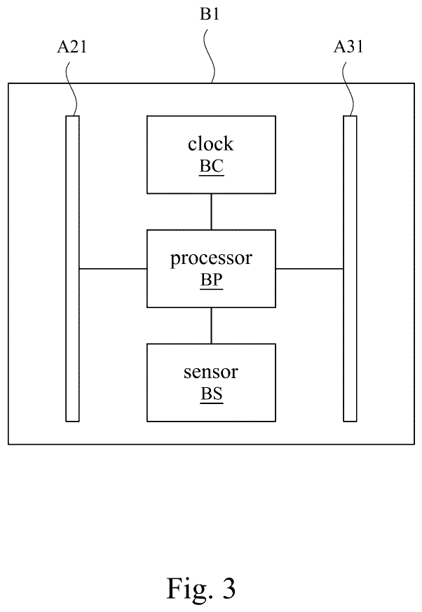

On the other hand, in some embodiments, the node substrate of each of the energy storage units E1-En (i.e., the node substrates B1-Bn) further comprises a second antenna and a third antenna. Please further refer to FIG. 3, which is a schematic diagram illustrating a node substrate B1 according to some embodiments of the present disclosure. For clarity, the disclosure takes the node substrate B1 as an illustration. Practically, the node substrates B1-Bn may be implemented as illustrated in FIG. 3.

As shown in FIG. 3, the node substrate B1 comprises a processor BP, a clock BC, a sensor BS, and antennas A21 and A31, wherein the processor BP is electrically connected to the clock BC, the sensor BS, and the antennas A21 and A31 respectively.

In some embodiments, the processor CP and/or the processor BP is configured to execute calculations and operations for controlling the control substrate CT and/or the node substrates B1-Bn, e.g., analyzing signals, generating commands, and/or controlling antennas to transmit signals. The processor CP and/or the processor BP comprises a central processing unit (CPU), a graphics processing unit (GPU), a microcontroller unit (MCU), a multi-processor, a distributed processing system, an application specific integrated circuit (ASIC), and/or a suitable processing unit.

The clock CC and/or the clock BC is configured to provide time information to the control substrate CT and/or the node substrates B1-Bn, in order to execute specific operations at specified time points or time periods.

The antennas A1, A21, and A31 is configured to transmit signals wirelessly for the control substrate CT and/or the node substrates B1-Bn to communicatively connect to other control substrate and/or node substrate.

The sensor BS is configured to measure the state of energy storage devices (e.g., the energy storage device D1) to obtain measurement data. For example, the sensor BS may comprise a voltmeter, an ammeter, an ohmmeter and/or a thermometer configured to measure the voltage, current, resistance and/or temperature of energy storage devices.

In some embodiments, the first antenna of the control substrate is communicatively connected to the second antenna of the first energy storage unit, and each of the energy storage units is communicatively connected to the second antenna or the third antenna of one of the energy storage units via the second antenna or the third antenna.

Furthermore, in some embodiments, the first antenna of the control substrate is placed on a side adjacent to the second antenna of the first energy storage unit, and the second antenna is placed on a side adjacent to the control substrate.

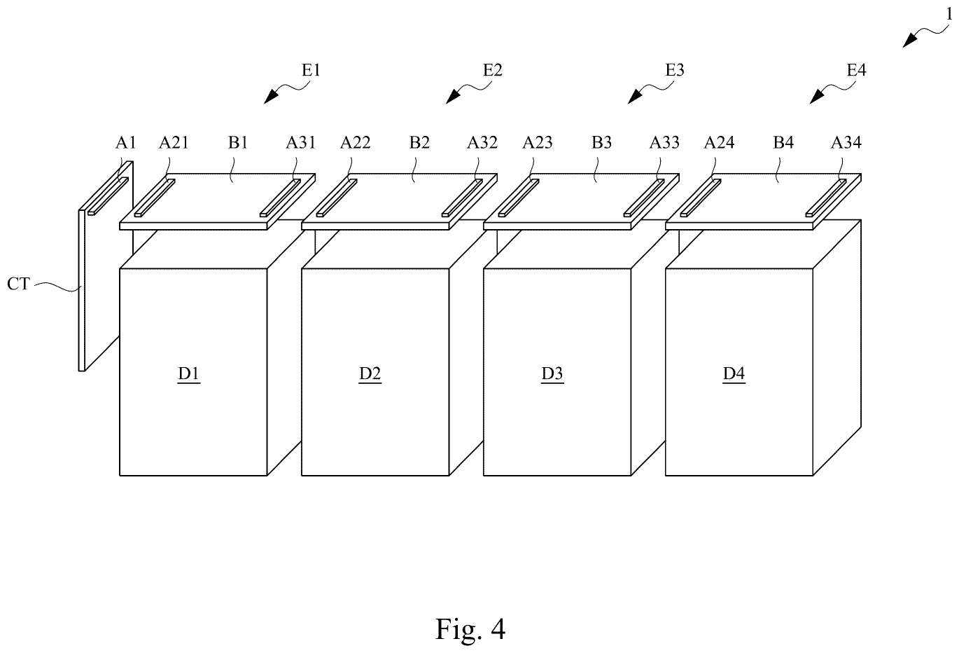

About the configuration of the wireless management system 1, please refer to FIG. 4. Taking the energy storage units E1-E4 as an example, the control substrate CT is set on a side of the energy storage unit E1, and the side of the control substrate CT on which the antenna A1 is placed is adjacent to the side of the node substrate B1 on which the antenna A21 is placed, so as to make the antenna A1 communicatively connect to the antenna A21 more efficiently. On the other hand, the energy storage devices D1-D4 are arranged in order, and the side of the node substrate B1 on which the antenna A31 is placed is adjacent to the side of the node substrate B2 on which the antenna A22 is placed, so as to make the antenna A31 communicatively connect to the antenna A22 more efficiently; the side of the node substrate B2 on which the antenna A32 is placed is adjacent to the side of the node substrate B3 on which the antenna A23 is placed, so as to make the antenna A32 communicatively connect to the antenna A23 more efficiently; and the side of the node substrate B3 on which the antenna A33 is placed is adjacent to the side of the node substrate B4 on which the antenna A24 is placed, so as to make the antenna A33 communicatively connect to the antenna A24 more efficiently.

As a result, by the pairwise arrangement of the antennas, the wireless management system 1 is able to establish a more efficient communication approach. Also, each of the control substrate CT and/or the energy storage units E1-E4 is able to recognize the connected object based on the signal strengths and reduce the impact of signal interference.

It is noted that, the embodiment shown in FIG. 4 is used for illustration, in other embodiments, the wireless management system 1 may be implemented in other arrangements.

The wireless management system 1 is configured to measure the energy storage devices D1-Dn at a designated time point and obtain the related data. First, in order to ensure that the energy storage units E1-En are able to execute operations at the time point designated by the control substrate CT, the wireless management system 1 synchronizes the clock CC of the control substrate CT and the clocks BC of the node substrates B1-Bn. Specifically, the wireless management system 1 synchronizes the first clock and the second clock of each of the energy storage units based on a first time calibration signal transmitted by the control substrate.

In some embodiments, the wireless management system 1 may performs clock synchronization by using Precision Time Protocol (PTP) provided by IEEE-1588 standard or other related method.

After synchronizing the clocks, the control substrate CT transmits a measurement signal to the node substrates B1-Bn. Correspondingly, after receiving the measurement signal, the node substrates B1-Bn measures the energy storage devices D1-Dn at the time point designated by the measurement signal to obtain measurement data such as voltage, current, resistance and/or temperature. Specifically, the energy storage units measuring the energy storage device of each of the energy storage units at a designated time point based on a measurement signal transmitted by the control substrate to obtain a plurality of measurement data corresponding to the designated time point, wherein the measurement signal is configured to indicate the designated time point.

After measuring the energy storage devices D1-Dn, the node substrates B1-Bn transmit a replay signal to send the measurement data to the control substrate CT. Specifically, the control substrate obtaining the measurement data corresponding to the designated time point from the energy storage units based on a reply signal transmitted by the energy storage units.

As a result, the wireless management system 1 is able to control the node substrates B1-Bn to return the measured data to the control substrate CT after measuring the energy storage devices D1-Dn at the designated time point and will not be interfered by the deviation of the clock of each of the node substrates B1-Bn. Additionally, through the daisy chain connection, each of the antennas on the control substrate CT and/or the node substrates B1-Bn only needs to communicate with a single object, and the impact of signal interference and the burden of signal recognition can be reduced.

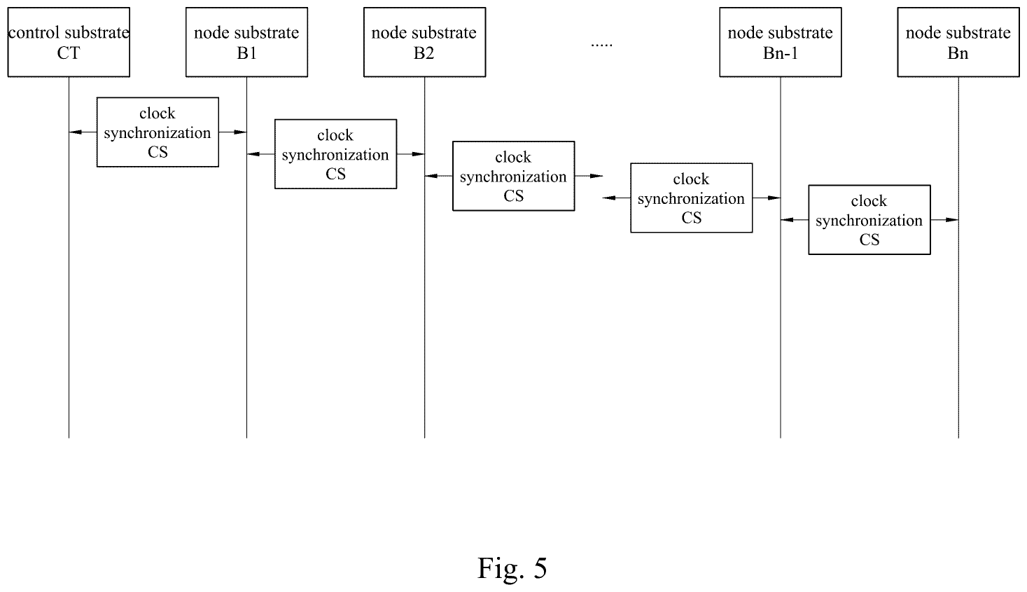

About the specific operations of clock synchronization, please refer to FIG. 5, which is a schematic diagram illustrating operations of the wireless management system synchronizing the clocks BC and CC according to some embodiments of the present disclosure.

First, the control substrate CT performs clock synchronization CS with the node substrate B1 it is communicatively connected to. Specifically, the operation of the wireless management system 1 synchronizing the first clock and the second clock of each of the energy storage units further comprises: the first energy storage unit transmitting a second time calibration signal to a second energy storage unit of the energy storage units; and the second energy storage unit executing a synchronous operation based on the second time calibration signal to synchronize the second clock of the first energy storage unit and the second clock of the second energy storage unit.

After completing the synchronization, the node substrate B1 performs clock synchronization CS with the node substrate B2 it is communicatively connected to. Specifically, the operation of the wireless management system synchronizing the first clock and the second clock of each of the energy storage units further comprises: the first energy storage unit transmitting a second time calibration signal to a second energy storage unit of the energy storage units; and the second energy storage unit executing a synchronous operation based on the second time calibration signal to synchronize the second clock of the first energy storage unit and the second clock of the second energy storage unit.

And so forth, until the clock synchronizations CS of the clocks of the control substrate CT and the node substrates B1-Bn are completed. Accordingly, the wireless management system 1 is able to synchronize the clock CC of the control substrate CT and the clocks BC of the node substrates B1-Bn.

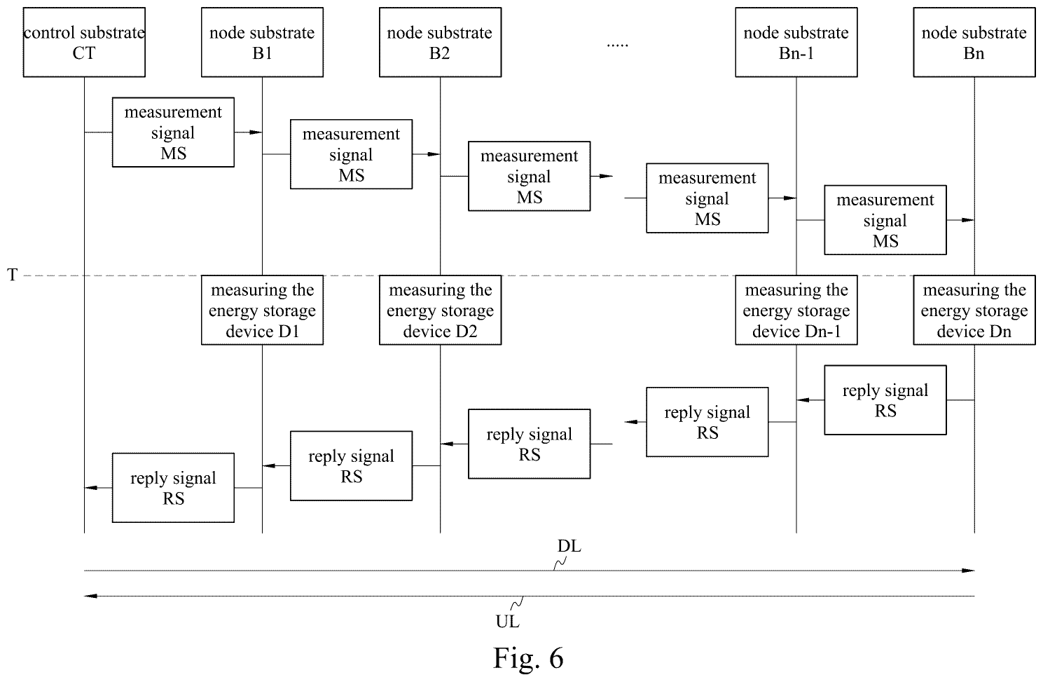

About the operation of the control substrate CT controlling the node substrates B1-Bn to measure the energy storage devices D1-Dn at the designated time point and return the measured data, please refer to FIG. 6. As shown in the figure, since the control substrate CT and the node substrates B1-Bn are communicatively connected in the form of a daisy chain, the direction from the control substrate CT, the node substrate B1, the node substrate B2 . . . to the node substrate Bn is called downlink direction DL; relatively, the direction from the node substrate Bn, the node substrate Bn−1, the node substrate Bn−2 . . . to the control substrate CT is called uplink direction UL.

First, starting from the control substrate CT, the wireless management system 1 transmits a measurement signal MS along the downlink direction DL to the node substrate Bn. Specifically, the measurement signal is transmitted by the control substrate along a downlink direction to the n-th energy storage unit, wherein the downlink direction comprises from the control substrate, the first energy storage unit, the second energy storage unit, the n−1-th energy storage unit to the n-th energy storage unit.

Taking FIG. 6 as an example, the control substrate CT transmits the measurement signal MS to the node substrate B1, wherein the measurement signal MS comprises an instruction for measuring energy storage devices at a time point T. After receiving the measurement signal MS, the node substrate B1 then transmit the measurement signal MS to the node substrate B2, and so forth, until the node substrate Bn receives the measurement signal MS.

Specifically, the operation of the energy storage units measuring the energy storage device of each of the energy storage units further comprises: the control substrate transmitting the measurement signal to the first energy storage unit; in response to receiving the measurement signal, the first energy storage unit transmitting the measurement signal to a second energy storage unit of the energy storage units; and in response to receiving the measurement signal, each of the energy storage units measuring the energy storage device at the designated time point based on the second clock to obtain each of the measurement data.

After receiving the measurement signal MS, the node substrates B1-Bn measure the energy storage devices D1-Dn correspondingly at the time point T and obtain the measurement data.

It is noted that, the embodiment shown in FIG. 6 takes the node substrates B1-Bn measuring the energy storage devices D1-Dn at the time point T simultaneously as an example. However, the embodiment is not limited thereto, the control substrate CT may also specifies the node substrates B1-Bn to measure the energy storage devices D1-Dn at different time points in other embodiments.

After obtaining measurement data, starting from the node substrate Bn, the wireless management system 1 transmits a reply signal RS along the uplink direction UL to the control substrate CT. Specifically, the reply signal is transmitted by the n-th energy storage unit along an uplink direction to the control substrate, wherein the uplink direction comprises from the n-th energy storage unit, the n−1-th energy storage unit, the second energy storage unit, the first energy storage unit to the control substrate.

Taking FIG. 6 as an example, the node substrate Bn transmits the reply signal RS to the node substrate Bn−1, wherein the reply signal RS transmitted by the node substrate Bn comprises the measurement data obtained by the node substrate Bn after measuring the energy storage device Dn. Furthermore, after receiving the reply signal RS, the node substrate Bn−1 adds the measurement data obtained after measuring the energy storage device Dn−1 into the reply signal RS and transmits the reply signal RS to the energy storage device Dn−2. And so forth, the reply signal RS finally received from the node substrate B1 by the control substrate CT will comprise the measurement data obtained after measuring the energy storage devices D1-Dn.

Specifically, the operation of the control substrate obtaining the measurement data further comprises: a second energy storage unit of the energy storage units transmitting the reply signal to the first energy storage unit, wherein the reply signal transmitted by the second energy storage unit comprises a second measurement data measured by the second energy storage unit; and in response to receiving the reply signal, the first energy storage unit transmitting the reply signal to the control substrate, wherein the reply signal transmitted by the first energy storage unit comprises the second measurement data and a first measurement data measured by the first energy storage unit.

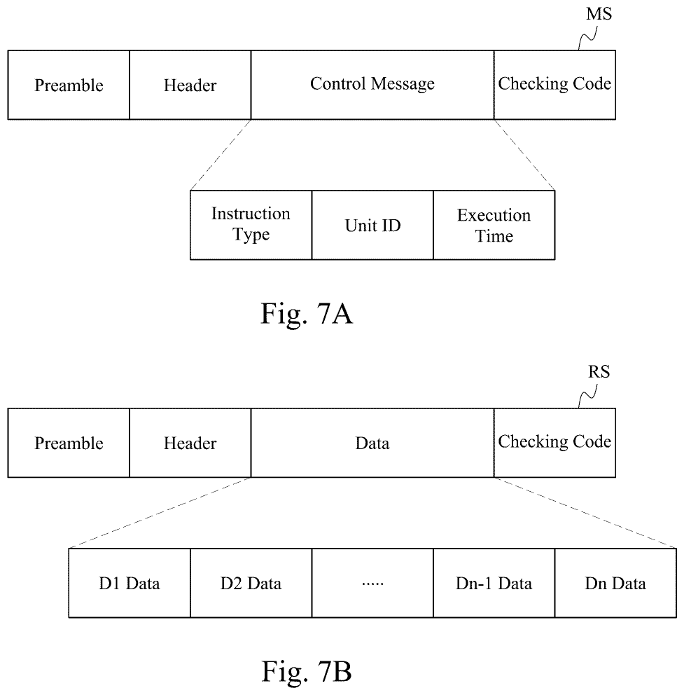

About the embodiment of the measurement signal MS, please refer to FIG. 7A, which is a schematic diagram illustrating a measurement signal MS according to some embodiments of the present disclosure. As shown in the figure, the measurement signal MS comprises preamble, header (e.g., MAC header), control message, and checking code (e.g., Cyclic Redundancy Check (CRC)).

The control message further comprises instruction type, energy storage unit ID, and execution time. The instruction type is configured to indicate the operation for the node substrates B1-Bn to execute, e.g., measuring the voltages, currents, resistances and/or temperatures of the energy storage devices D1-Dn. The energy storage unit ID is configured to indicate the object which the measurement signal MS is transmitted to, e.g., which node substrates are specified by the control substrate CT to execute the instruction. The execution time is configured to indicate the time point when the instruction is executed, e.g., the time point T shown in FIG. 6.

In other hand, about the embodiment of the reply signal RS, please refer to FIG. 7B, which is a schematic diagram illustrating a reply signal RS according to some embodiments of the present disclosure. As shown in the figure, the reply signal RS comprises preamble, header (e.g., MAC header), data, and checking code (e.g., Cyclic Redundancy Check (CRC)).

The data further comprises the data corresponding to the energy storage devices D1-Dn. Taking the embodiment shown in FIG. 6 as an example, the node substrate Bn adds the measurement data corresponding to the energy storage device Dn into the data field in the reply signal RS and transmits the reply signal RS to the node substrate Bn−1; the node substrate Bn−1 adds the measurement data corresponding to the energy storage device Dn−1 into the data field in the reply signal RS and transmits the reply signal RS to the node substrate Bn−2. And so forth, the reply signal RS received from the node substrate B1 by the control substrate CT will comprise the measurement data corresponding to the energy storage devices D1-Dn.

In some embodiments, each of the node substrates B1-Bn further comprises a register (not shown in the figures) configured to store the measurement data, the measurement signal MS, and/or the reply signal RS, so as to make the node substrates B1-Bn complete the above functions.

In summary, the wireless management system 1 provided by the present disclosure is able to control the energy storage units E1-En to execute specific operations at a specified time point through synchronizing the clock CC of the control substrate CT and the clocks BC of the node substrates B1-Bn. Additionally, based on the daisy chain connection, the wireless management system 1 is able to reduce the impact of signal interference and the burden of signal recognition. Accordingly, the present disclosure provides a reliable wireless management technology that can be automatically produced.

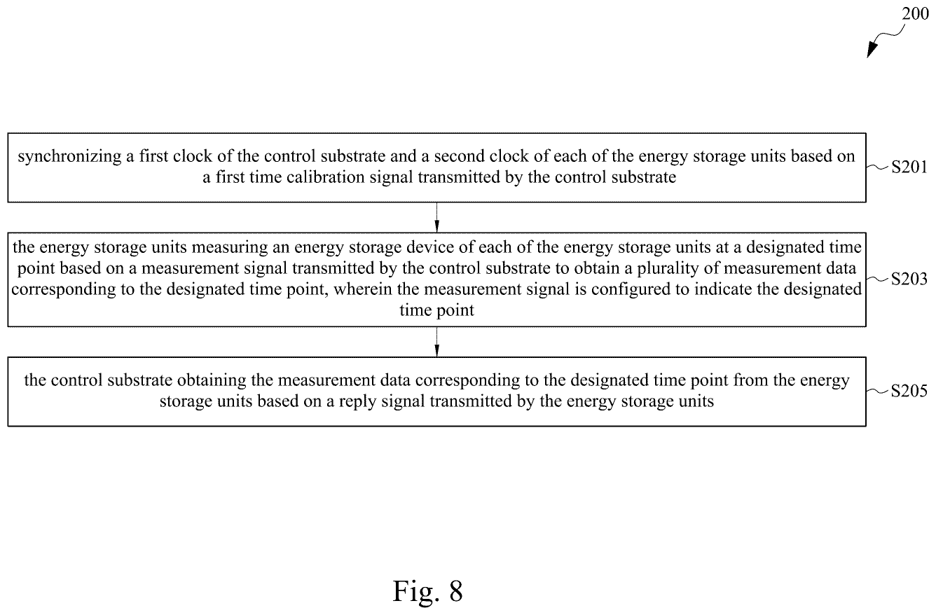

Please refer to FIG. 8, which is a flow diagram illustrating a wireless management method according to a second embodiment of the present disclosure. The wireless management method 200 comprises steps S201, S203, and S205. The wireless management method 200 is configured to measure energy storage devices at a designated time point and obtain the related data. The wireless management method 200 can be executed by a wireless management system (e.g., the wireless management system 1 in the first embodiment), wherein the wireless management system comprises a control substrate and a plurality of energy storage units, and a first energy storage unit of the energy storage units is communicatively connected to the control substrate.

First, in the step S201, the wireless management system synchronizes a first clock of the control substrate and a second clock of each of the energy storage units based on a first time calibration signal transmitted by the control substrate.

Next, in the step S203, the energy storage units measuring an energy storage device of each of the energy storage units at a designated time point based on a measurement signal transmitted by the control substrate to obtain a plurality of measurement data corresponding to the designated time point, wherein the measurement signal is configured to indicate the designated time point.

Finally, in the step S205, the control substrate obtaining the measurement data corresponding to the designated time point from the energy storage units based on a reply signal transmitted by the energy storage units.

In some embodiments, the control substrate further comprises a first antenna, a node substrate of each of the energy storage units further comprises a second antenna and a third antenna, the first antenna of the control substrate is communicatively connected to the second antenna of the first energy storage unit, and each of the energy storage units is communicatively connected to the second antenna or the third antenna of one of the energy storage units via the second antenna or the third antenna.

In some embodiments, the first antenna of the control substrate is placed on a side adjacent to the second antenna of the first energy storage unit, and the second antenna is placed on a side adjacent to the control substrate.

In some embodiments, the step S201 further comprises the control substrate transmitting the first time calibration signal to the first energy storage unit; and the first energy storage unit executing a synchronous operation based on the first time calibration signal to synchronize the first clock and the second clock of the first energy storage unit.

In some embodiments, the step S201 further comprises the first energy storage unit transmitting a second time calibration signal to a second energy storage unit of the energy storage units; and the second energy storage unit executing a synchronous operation based on the second time calibration signal to synchronize the second clock of the first energy storage unit and the second clock of the second energy storage unit.

In some embodiments, the step S203 further comprises the control substrate transmitting the measurement signal to the first energy storage unit; in response to receiving the measurement signal, the first energy storage unit transmitting the measurement signal to a second energy storage unit of the energy storage units; and in response to receiving the measurement signal, each of the energy storage units measuring the energy storage device at the designated time point based on the second clock to obtain each of the measurement data.

In some embodiments, the step S205 further comprises a second energy storage unit of the energy storage units transmitting the reply signal to the first energy storage unit, wherein the reply signal transmitted by the second energy storage unit comprises a second measurement data measured by the second energy storage unit; and in response to receiving the reply signal, the first energy storage unit transmitting the reply signal to the control substrate, wherein the reply signal transmitted by the first energy storage unit comprises the second measurement data and a first measurement data measured by the first energy storage unit.

In some embodiments, the energy storage units further comprise a second energy storage unit to a n-th energy storage unit, the first energy storage unit to the n-th energy storage unit are communicatively connected in sequence pairwisely, the n-th energy storage unit is adjacent to a n−1-th energy storage unit, and n is a positive integer greater than 1.

In some embodiments, the measurement signal is transmitted by the control substrate along a downlink direction to the n-th energy storage unit, wherein the downlink direction comprises from the control substrate, the first energy storage unit, the second energy storage unit, the n−1-th energy storage unit to the n-th energy storage unit.

In some embodiments, the reply signal is transmitted by the n-th energy storage unit along an uplink direction to the control substrate, wherein the uplink direction comprises from the n-th energy storage unit, the n−1-th energy storage unit, the second energy storage unit, the first energy storage unit to the control substrate.

In some embodiments, the node substrate of each of the energy storage units further comprise a register configured to store the measurement data, the measurement signal, and/or the reply signal.

In summary, the wireless management method 200 provided by the present disclosure is able to control the energy storage units to execute specific operations at a specified time point through synchronizing the clock of the control substrate and the clocks of the node substrates. Additionally, based on the daisy chain connection, the wireless management method 200 is able to reduce the impact of signal interference and the burden of signal recognition. Accordingly, the present disclosure provides a reliable wireless management technology that can be automatically produced.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A wireless management system, comprising:
a control substrate, comprising a first clock; and
a plurality of energy storage units, wherein a first energy storage unit of the energy storage units is communicatively connected to the control substrate, each of the energy storage units is communicatively connected to one of the energy storage units, and each of the energy storage units comprises:
an energy storage device; and
a node substrate, electrically connected to the energy storage device, wherein the node substrate comprises a second clock;
wherein the wireless management system is configured to execute the following operations:
synchronizing the first clock and the second clock of each of the energy storage units based on a first time calibration signal transmitted by the control substrate;
the energy storage units measuring the energy storage device of each of the energy storage units at a designated time point based on a measurement signal transmitted by the control substrate to obtain a plurality of measurement data corresponding to the designated time point, wherein the measurement signal is configured to indicate the designated time point; and
the control substrate obtaining the measurement data corresponding to the designated time point from the energy storage units based on a reply signal transmitted by the energy storage units.

2. The wireless management system of claim 1, wherein the control substrate further comprises a first antenna, the node substrate of each of the energy storage units further comprises a second antenna and a third antenna, the first antenna of the control substrate is communicatively connected to the second antenna of the first energy storage unit, and each of the energy storage units is communicatively connected to the second antenna or the third antenna of one of the energy storage units via the second antenna or the third antenna.

3. The wireless management system of claim 2, wherein the first antenna of the control substrate is placed on a side adjacent to the second antenna of the first energy storage unit, and the second antenna is placed on a side adjacent to the control substrate.

4. The wireless management system of claim 1, wherein the operation of synchronizing the first clock and the second clock of each of the energy storage units further comprises:
the control substrate transmitting the first time calibration signal to the first energy storage unit; and
the first energy storage unit executing a synchronous operation based on the first time calibration signal to synchronize the first clock and the second clock of the first energy storage unit.

5. The wireless management system of claim 1, wherein the operation of synchronizing the first clock and the second clock of each of the energy storage units further comprises:
the first energy storage unit transmitting a second time calibration signal to a second energy storage unit of the energy storage units; and
the second energy storage unit executing a synchronous operation based on the second time calibration signal to synchronize the second clock of the first energy storage unit and the second clock of the second energy storage unit.

6. The wireless management system of claim 1, wherein the operation of the energy storage units measuring the energy storage device of each of the energy storage units further comprises:
the control substrate transmitting the measurement signal to the first energy storage unit;
in response to receiving the measurement signal, the first energy storage unit transmitting the measurement signal to a second energy storage unit of the energy storage units; and
in response to receiving the measurement signal, each of the energy storage units measuring the energy storage device at the designated time point based on the second clock to obtain each of the measurement data.

7. The wireless management system of claim 1, wherein the operation of the control substrate obtaining the measurement data further comprises:
a second energy storage unit of the energy storage units transmitting the reply signal to the first energy storage unit, wherein the reply signal transmitted by the second energy storage unit comprises a second measurement data measured by the second energy storage unit; and
in response to receiving the reply signal, the first energy storage unit transmitting the reply signal to the control substrate, wherein the reply signal transmitted by the first energy storage unit comprises the second measurement data and a first measurement data measured by the first energy storage unit.

8. The wireless management system of claim 1, wherein the energy storage units further comprise a second energy storage unit to a n-th energy storage unit, the first energy storage unit to the n-th energy storage unit are communicatively connected in sequence pairwisely, the n-th energy storage unit is adjacent to a n−1-th energy storage unit, and n is a positive integer greater than 1.

9. The wireless management system of claim 8, wherein the measurement signal is transmitted by the control substrate along a downlink direction to the n-th energy storage unit, wherein the downlink direction comprises from the control substrate, the first energy storage unit, the second energy storage unit, the n−1-th energy storage unit to the n-th energy storage unit.

10. The wireless management system of claim 8, wherein the reply signal is transmitted by the n-th energy storage unit along an uplink direction to the control substrate, wherein the uplink direction comprises from the n-th energy storage unit, the n−1-th energy storage unit, the second energy storage unit, the first energy storage unit to the control substrate.

11. A wireless management method, being adapted for use in a wireless management system, wherein the wireless management system comprises a control substrate and a plurality of energy storage units, a first energy storage unit of the energy storage units is communicatively connected to the control substrate, and the wireless management method comprises the following steps:
synchronizing a first clock of the control substrate and a second clock of each of the energy storage units based on a first time calibration signal transmitted by the control substrate;
the energy storage units measuring an energy storage device of each of the energy storage units at a designated time point based on a measurement signal transmitted by the control substrate to obtain a plurality of measurement data corresponding to the designated time point, wherein the measurement signal is configured to indicate the designated time point; and
the control substrate obtaining the measurement data corresponding to the designated time point from the energy storage units based on a reply signal transmitted by the energy storage units.

12. The wireless management method of claim 11, wherein the control substrate further comprises a first antenna, a node substrate of each of the energy storage units further comprises a second antenna and a third antenna, the first antenna of the control substrate is communicatively connected to the second antenna of the first energy storage unit, and each of the energy storage units is communicatively connected to the second antenna or the third antenna of one of the energy storage units via the second antenna or the third antenna.

13. The wireless management method of claim 12, wherein the first antenna of the control substrate is placed on a side adjacent to the second antenna of the first energy storage unit, and the second antenna is placed on a side adjacent to the control substrate.

14. The wireless management method of claim 11, wherein the step of synchronizing the first clock and the second clock of each of the energy storage units further comprises:
the control substrate transmitting the first time calibration signal to a first energy storage unit of the energy storage units; and
the first energy storage unit executing a synchronous operation based on the first time calibration signal to synchronize the first clock and the second clock of the first energy storage unit.

15. The wireless management method of claim 11, wherein the step of synchronizing the first clock and the second clock of each of the energy storage units further comprises:
the first energy storage unit transmitting a second time calibration signal to a second energy storage unit of the energy storage units; and
the second energy storage unit executing a synchronous operation based on the second time calibration signal to synchronize the second clock of the first energy storage unit and the second clock of the second energy storage unit.

16. The wireless management method of claim 11, wherein the step of the energy storage units measuring the energy storage device of each of the energy storage units further comprises:
the control substrate transmitting the measurement signal to the first energy storage unit;
in response to receiving the measurement signal, the first energy storage unit transmitting the measurement signal to a second energy storage unit of the energy storage units; and
in response to receiving the measurement signal, each of the energy storage units measuring the energy storage device at the designated time point based on the second clock to obtain each of the measurement data.

17. The wireless management method of claim 11, wherein the step of the control substrate obtaining the measurement data further comprises:
a second energy storage unit of the energy storage units transmitting the reply signal to the first energy storage unit, wherein the reply signal transmitted by the second energy storage unit comprises a second measurement data measured by the second energy storage unit; and
in response to receiving the reply signal, the first energy storage unit transmitting the reply signal to the control substrate, wherein the reply signal transmitted by the first energy storage unit comprises the second measurement data and a first measurement data measured by the first energy storage unit.

18. The wireless management method of claim 11, wherein the energy storage units further comprise a second energy storage unit to a n-th energy storage unit, the first energy storage unit to the n-th energy storage unit are communicatively connected in sequence pairwisely, the n-th energy storage unit is adjacent to a n−1-th energy storage unit, and n is a positive integer greater than 1.

19. The wireless management method of claim 18, wherein the measurement signal is transmitted by the control substrate along a downlink direction to the n-th energy storage unit, wherein the downlink direction comprises from the control substrate, the first energy storage unit, the second energy storage unit, the n−1-th energy storage unit to the n-th energy storage unit.

20. The wireless management method of claim 18, wherein the reply signal is transmitted by the n-th energy storage unit along an uplink direction to the control substrate, wherein the uplink direction comprises from the n-th energy storage unit, the n−1-th energy storage unit, the second energy storage unit, the first energy storage unit to the control substrate.
